(19) United States
(12) Patent Application Publication
(10) Pub. No.: US 2025/0014558 A1
(43) Pub. Date: Jan. 9, 2025

(54) IMAGE FORMING APPARATUS

(71) Applicant: CANON KABUSHIKI KAISHA, Tokyo (JP)

(72) Inventor: MASUMI SONE, Chiba (JP)

(21) Appl. No.: 18/759,510

(22) Filed: Jun. 28, 2024

(30) Foreign Application Priority Data
Jul. 3, 2023 (JP) 2023-109349
May 14, 2024 (JP) 2024-078705

(51) Int. Cl. G10K 11/162; G03G 15/00

(52) U.S. Cl. CPC G10K 11/162; G03G 15/6552

(57) ABSTRACT

An image forming apparatus includes an image forming portion, a discharge port configured to discharge a recording medium on which the image is formed by the image forming portion, a wall portion in which the discharge port is provided, a bottom portion on which the recording medium is to be stacked, an upper portion opposed to the bottom portion, a side portion provided along a discharge direction of the recording medium, a discharge space defined by at least the wall portion, the bottom portion, the upper portion, and the side portion, and accommodating the recording medium discharged from the discharge port a plurality of through-holes provided in any portion or portions of at least the wall portion, the bottom portion, the upper portion, and the side portion, and a sound absorbing material covering the plurality of through-holes on a side opposite to the discharge space.

### BACKGROUND OF THE DISCLOSURE

### Field of the Disclosure

The present disclosure relates to an image forming apparatus including a sound absorbing material.

### Description of the Related Art

In recent years, an image forming apparatus such as a copying machine has been widely spread, and has become to be installed in various usage environments. Accordingly, quietness at the time of operation, which has been relatively low in priority in the related art, is also becoming more and more important. Meanwhile, in an office machine, along with an increase in printing speed, sounds generated inside of the apparatus, such as a driving sound, a paper sound, and a fan sound, tend to increase, and sound reduction is now a great issue. In particular, an in-body discharge space (discharged recording medium accommodating space) for accommodating a recording medium having an image formed thereon is always an open space so that a user can immediately access the recording medium. The sound generated inside of the apparatus is output from a discharge port to leak to the outside of the image forming apparatus.

In order to address such a problem, in Japanese Patent Application Laid-Open No. 2017-156766, there has been proposed a technology of providing a sound absorbing unit using a Helmholtz resonator on an upper surface of an in-body discharge space for accommodating a recording medium having an image formed thereon by an image forming portion.

However, in recent years, the image forming apparatus is desired to be further downsized, and there is a limit to a space for installing the sound absorbing unit using the Helmholtz resonator in the image forming apparatus. The Helmholtz resonator has a shape like a container with a narrowed port, and a space for providing a cavity portion in the Helmholtz resonator is required to be secured. This space leads to an increase in size of a main body of the image forming apparatus. Further, a sound absorbing hole serving as a sound absorbing portion has a dimension smaller than that of the internal cavity portion, and hence the number of sound absorbing holes that can be arranged is restricted by the size of the cavity portion.

### SUMMARY OF THE DISCLOSURE

According to an aspect of the present disclosure, an image forming apparatus includes an image forming portion configured to form an image on a recording medium, a discharge port configured to discharge the recording medium on which the image is formed by the image forming portion, a wall portion in which the discharge port is provided, a bottom portion on which the recording medium discharged from the discharge port is to be stacked, an upper portion provided so as to be opposed to the bottom portion, a side portion provided along a discharge direction of the recording medium discharged from the discharge port, a discharge space defined by at least the wall portion, the bottom portion, the upper portion, and the side portion, wherein the discharge space accommodates the recording medium discharged from the discharge port, a plurality of through-holes provided in any portion or portions of at least the wall portion, the bottom portion, the upper portion, and the side portion, and a sound absorbing material provided so as to cover the plurality of through-holes on a side opposite to the discharge space with respect to the portion or portions of at least the wall portion, the bottom portion, the upper portion, and the side portion in which the plurality of through-holes are provided.

Further features of the present disclosure will become apparent from the following description of exemplary embodiments with reference to the attached drawings.

### BRIEF DESCRIPTION OF THE DRAWINGS

FIG. 1 is a perspective view of an image forming apparatus according to a first embodiment.

FIG. 2 is a sectional view of the image forming apparatus according to the first embodiment.

FIG. 3 is a perspective view of an in-body discharge space in the first embodiment.

FIG. 4 is a sectional view of the image forming apparatus given when a discharge tray in the first embodiment is seen from above.

FIG. 5 is a schematic view for illustrating a back side of an in-body discharge cover in the first embodiment.

FIG. 6A, FIG. 6B, and FIG. 6C are schematic views of a perforated surface of the in-body discharge cover in the first embodiment.

FIG. 7 is a sectional view of the perforated surface of the in-body discharge cover and a sound absorbing sheet in the first embodiment.

FIG. 8 is a perspective view for illustrating an in-body discharge space of an image forming apparatus according to another embodiment.

FIG. 9A, FIG. 9B, and FIG. 9C are views for illustrating an in-body discharge cover and a sound absorbing sheet in another embodiment.

FIG. 10 is a sectional view of an image forming apparatus according to a second embodiment.

FIG. 11 is a sectional view of an image forming apparatus according to a third embodiment.

### DESCRIPTION OF THE EMBODIMENTS

Now, modes for carrying out the present disclosure are described with reference to the accompanying drawings.

### First Embodiment

Now, an image forming apparatus 1 according to a first embodiment is described with reference to the accompanying drawings. A sound absorbing unit of the first embodiment is used in, for example, the image forming apparatus 1 as described later, but is not always limited to this mode. In the following, embodiments of the present disclosure are illustratively described in detail hereinafter with reference to the drawings. However, sizes, materials, and shapes of components described in the following embodiments, and their relative positions, are subject to appropriate change in accordance with a configuration and various conditions of an apparatus to which the present disclosure is applied. Accordingly, as long as there is no specific description, it is not intended to limit the scope of the present disclosure only to those exemplary embodiments.

### (Image Forming Apparatus)

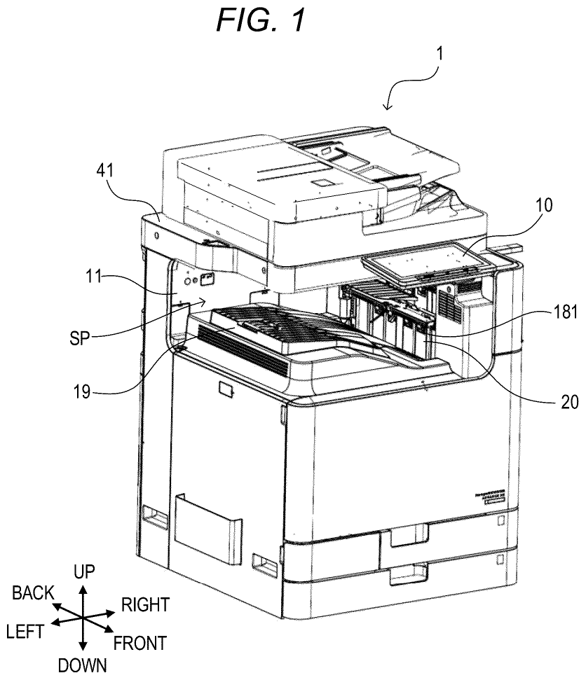

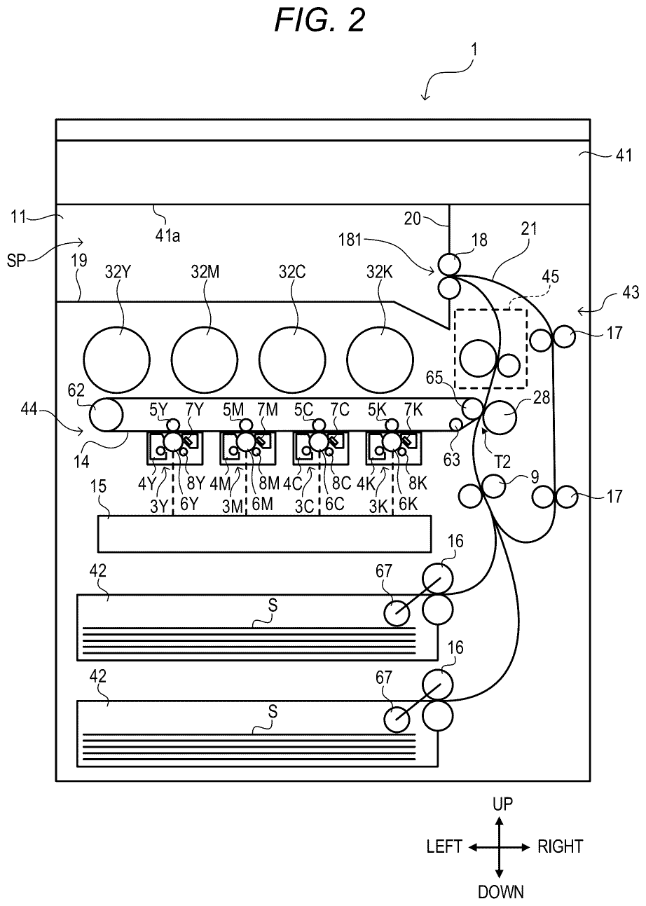

FIG. 1 is a perspective view of the image forming apparatus 1 according to the first embodiment. FIG. 2 is a sectional view of the image forming apparatus 1 according to the first embodiment. The image forming apparatus 1 according to the first embodiment is an in-body discharge type image forming apparatus. In the image forming apparatus 1 according to the first embodiment, a side on which a user stands at the time of operating an operation portion 10 is referred to as “front,” and a side opposite thereto is referred to as “back.” Further, the left as viewed from the front is referred to as “left,” and the right as viewed from the front is referred to as “right.” Thus, FIG. 2 shows a cross-section of the image forming apparatus 1 given when the image forming apparatus 1 is seen from the front.

With reference to FIG. 1 and FIG. 2, the image forming apparatus 1 includes an original reading portion (reader) 41, sheet feeding portions 42, a sheet conveying portion 43, an image forming portion 44, a fixing portion 45, and the operation portion 10. The image forming portion 44 includes four photosensitive drums 6Y, 6M, 6C, and 6K used for forming toner images. Each of the photosensitive drums 6Y, 6M, 6C, and 6K rotates clockwise in FIG. 2. Around the photosensitive drums 6Y, 6M, 6C, and 6K, charging devices 8Y, 8M, 8C, and 8K, developing devices 4Y, 4M, 4C, and 4K, and cleaners 7Y, 7M, 7C, and 7K are arranged, respectively. The photosensitive drums 6Y, 6M, 6C, and 6K, the charging devices 8Y, 8M, 8C, and 8K, the developing devices 4Y, 4M, 4C, and 4K, and the cleaners 7Y, 7M, 7C, and 7K form image forming units 3Y, 3M, 3C, and 3K as process cartridges, respectively. The image forming units 3Y, 3M, 3C, and 3K form the image forming portion 44 serving as an image forming section.

Above the image forming portion 44, an intermediate transfer belt 14 serving as an intermediate transfer unit is arranged so as to come into contact with the photosensitive drums 6Y, 6M, 6C, and 6K. The intermediate transfer belt 14 is stretched by a drive roller 62 and two driven rollers 63 and 65. The intermediate transfer belt 14 rotates counterclockwise in FIG. 2. Primary transfer rollers 5Y, 5M, 5C, and 5K are provided so as to be opposed to the photosensitive drums 6Y, 6M, 6C, and 6K, respectively, across the intermediate transfer belt 14. The primary transfer rollers 5Y, 5M, 5C, and 5K form primary transfer portions between the intermediate transfer belt 14 and the photosensitive drums 6Y, 6M, 6C, and 6K, respectively. Above the intermediate transfer belt 14, toner replenishing portions 32Y, 32M, 32C, and 32K for supplying toners of respective colors to the developing devices 4Y, 4M, 4C, and 4K are provided.

The image forming unit 3Y forms a yellow toner image, the image forming unit 3M forms a magenta toner image, the image forming unit 3C forms a cyan toner image, and the image forming unit 3K forms a black toner image. The image forming units 3Y, 3M, 3C, and 3K have substantially the same structure, and hence the image forming unit 3Y is hereinafter described. A surface of the photosensitive drum 6Y is uniformly charged by the charging device 8Y. An exposure unit 15 radiates light modified based on a yellow image signal to the uniformly-charged surface of the photosensitive drum 6Y, to thereby form a latent image on the surface of the photosensitive drum 6Y. The developing device 4Y develops the latent image formed on the surface of the photosensitive drum 6Y with yellow toner supplied from the toner replenishing portion 32Y, to thereby form a yellow toner image on the photosensitive drum 6Y.

Along with the rotation of the photosensitive drum 6Y, the yellow toner image reaches the primary transfer portion at which the photosensitive drum 6Y and the intermediate transfer belt 14 abut against each other. A primary transfer bias is applied from an electrical board (not shown) to the primary transfer roller 5Y disposed so as to be opposed to the photosensitive drum 6Y, and thus the primary transfer roller 5Y transfers the yellow toner image formed on the surface of the photosensitive drum 6Y onto the intermediate transfer belt 14. Similarly, the magenta, cyan, and black toner images formed on surfaces of the photosensitive drums 6M, 6C, and 6K are sequentially transferred onto the intermediate transfer belt 14 by the primary transfer rollers 5M, 5C, and 5K.

A sheet S, serving as a recording medium accommodated in the sheet feeding portion 42 serving as a feeding unit, is fed by a pickup roller 67 and is separated one by one by a separation feeding portion 16 to be fed to registration rollers 9. The registration rollers 9 start conveyance of the sheet S in synchronization with the timing of the toner images transferred onto the intermediate transfer belt 14, and convey the sheet S to a secondary transfer portion T2 formed between a secondary transfer roller 28 and the intermediate transfer belt 14. The secondary transfer roller 28 transfers the toner images formed on the intermediate transfer belt 14 onto the sheet S at the secondary transfer portion T2. The sheet S having the toner images transferred thereon is conveyed to the fixing portion 45. The fixing portion 45 applies heat and pressure to the sheet S, and thus the toners are melted and mixed to be fixed on the sheet S so that a color image is formed on the sheet S. The sheet S having the image formed thereon is discharged to a discharge tray 19 by discharge rollers 18 provided downstream of the fixing portion 45. The discharge rollers 18 include a discharge port 181 for discharging the sheet S.

The image forming apparatus 1 can operate in a simplex printing mode of forming an image on one surface of the sheet S and a duplex printing mode of forming images on both surfaces of the sheet S. In the simplex printing mode, the sheet S having an image formed on one surface of the sheet S as described above is discharged to the discharge tray 19 by the discharge rollers 18. In the duplex printing mode, the sheet S having an image formed on one surface (first surface) thereof is conveyed to a reverse conveyance path 21 through reverse rotation of the discharge rollers 18. The sheet S is reconveyed to the secondary transfer portion T2 by reverse conveyance rollers 17 arranged in the reverse conveyance path 21. At the secondary transfer portion T2, toner images are transferred onto a back surface (second surface) of the sheet S. The sheet S is conveyed to the fixing portion 45, and the toner images are fixed to the back surface of the sheet S so that a color image is formed. The sheet S having images formed on both surfaces thereof is discharged to the discharge tray 19 by the discharge rollers 18.

### (In-Body Discharge Space)

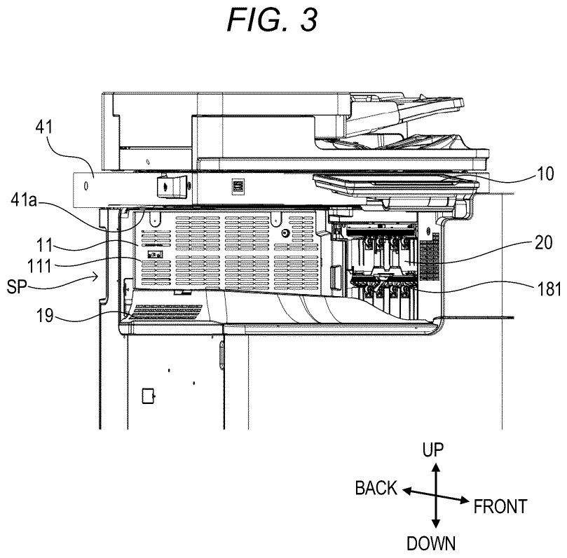

Next, with reference to FIG. 3, an in-body discharge space SP serving as a discharge space of the image forming apparatus 1 according to the first embodiment is described. FIG. 3 is a perspective view of the in-body discharge space SP in the first embodiment. In the image forming apparatus 1, the original reading portion 41 is arranged above the discharge tray 19 on which the sheet S discharged from the discharge port 181 is to be stacked. The in-body discharge space SP in which the sheet S discharged from the discharge port 181 is to be accommodated is formed between the discharge tray 19 and the original reading portion 41. In the image forming apparatus 1, the image forming portion 44 is provided below the in-body discharge space SP. In the image forming apparatus 1, an in-body discharge cover 11 is provided on the back side of the in-body discharge space SP. In the image forming apparatus 1, a discharge port surface (wall portion) 20 in which the discharge port 181 is formed is provided on the right side of the in-body discharge space SP. The in-body discharge space SP is defined by at least four surfaces including the discharge tray 19 serving as a bottom surface (bottom portion), the discharge port surface 20, a lower surface 41a of the original reading portion 41 serving as an upper surface (upper portion), and the in-body discharge cover 11 serving as a side surface (side portion).

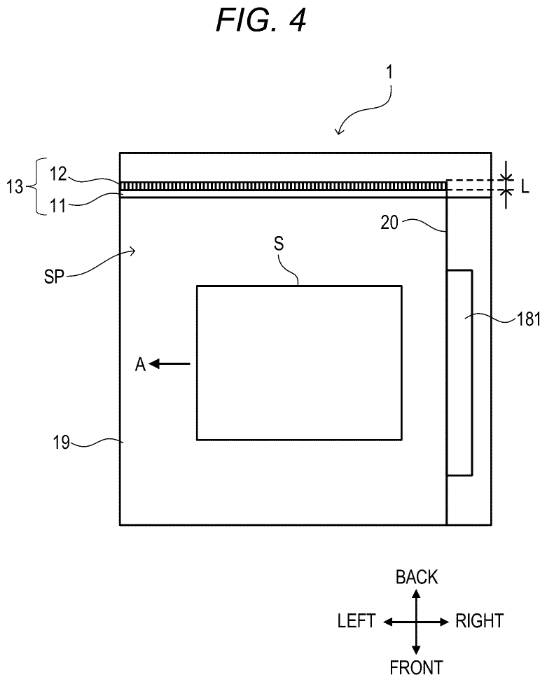

FIG. 4 is a sectional view of the image forming apparatus 1 given when the discharge tray 19 in the first embodiment is seen from above. The sheet S discharged from the discharge port 181 is stacked on the discharge tray 19 in the in-body discharge space SP. The in-body discharge cover 11 serving as a perforated plate is provided on the back side of the in-body discharge space SP. The arrow of FIG. 4 indicates a discharge direction A of the sheet S discharged from the discharge port 181. The in-body discharge cover 11 forms the side surface (side portion) provided along the discharge direction A of the in-body discharge space SP.

A sound absorbing sheet (sound absorbing material) 12 is provided in abutment on the back side of the in-body discharge cover 11. The in-body discharge cover 11 and the sound absorbing sheet 12 form a sound absorbing device 13 for absorbing a sound output from the discharge port 181. The sound absorbing sheet 12 is formed of a sheet-shaped member having sound absorbing performance, such as an ethylene propylene diene rubber-based (EPDM-based) or urethane-based foam, a glass wool material made of glass fibers, or a mineral rockwool material. However, in place of the sound absorbing sheet 12, for example, a plate-shaped, block-shaped, or cotton-shaped sound absorbing material may be used. The in-body discharge cover 11 has a plurality of sound absorbing holes 111 formed therein. The plurality of sound absorbing holes 111 are a plurality of through-holes passing through the in-body discharge cover 11. All of the plurality of sound absorbing holes 111 are covered with the sound absorbing sheet 12 on the back side of the in-body discharge cover 11. In this case, the phrase “the plurality of sound absorbing holes 111 are covered with the sound absorbing sheet 12 on the back side of the in-body discharge cover 11” means that the in-body discharge cover 11 and the sound absorbing sheet 12 are adjacent to each other and the plurality of sound absorbing holes 111 and the sound absorbing sheet 12 overlap each other as viewed from a direction orthogonal to the in-body discharge cover 11. A part of a main body operating sound output from the discharge port 181 passes through the sound absorbing holes 111 to enter the sound absorbing sheet 12, and part of sound energy is converted into thermal energy when the sound is greatly diffused in the sound absorbing sheet 12. Thus, a sound leaking to the outside of the apparatus main body is reduced.

The plurality of sound absorbing holes 111 and the sound absorbing sheet 12 covering those holes may be provided in the entire region of the in-body discharge cover 11, or may be provided in a part of the in-body discharge cover 11. The plurality of sound absorbing holes 111 and the sound absorbing sheet 12 covering those holes may be provided in a plurality of parts of the in-body discharge cover 11. Further, the plurality of sound absorbing holes 111 and the sound absorbing sheet 12 covering those holes may be provided in a part of the in-body discharge cover 11 on a side opposite to the discharge port 181 with respect to a center position in the discharge direction A of the sheet S. When the plurality of sound absorbing holes 111 and the sound absorbing sheet 12 covering those holes are provided near an opening portion of the in-body discharge space SP, a sound transmitted to the user from the in-body discharge space SP can be reduced.

In the first embodiment, the in-body discharge cover 11 and the sound absorbing sheet 12 are in contact with each other. When the in-body discharge cover 11 and the sound absorbing sheet 12 are in contact with each other, the vibration of the in-body discharge cover 11 is reduced by the sound absorbing sheet 12. Thus, with the contact between the in-body discharge cover 11 and the sound absorbing sheet 12, further effective sound reduction of the image forming apparatus 1 can be achieved. In the first embodiment, the sound absorbing sheet (sound absorbing material) 12 is provided in abutment against the in-body discharge cover 11, but the sound absorbing sheet 12 may be arranged so as to be separated apart from the in-body discharge cover 11.

In general, it is preferred that the sound absorbing sheet 12 be thicker because a thicker sound absorbing sheet 12 can adapt to a sound of a wider frequency band and thus the sound reduction effect is likely to be obtained. In the first embodiment, in order to obtain a high effect with low cost, a sound absorbing sheet 12 having a thickness of “5 mm” formed of an EPDM-based foam is used. When an EPDM-based or urethane-based sound absorbing sheet 12 is used, it becomes difficult to obtain the sound reduction effect when the sound absorbing sheet 12 is compressed. In view of the above, the sound absorbing sheet 12 is mounted between the in-body discharge cover 11 and a wall surface of the apparatus main body so as to prevent the sound absorbing sheet 12 from being compressed.

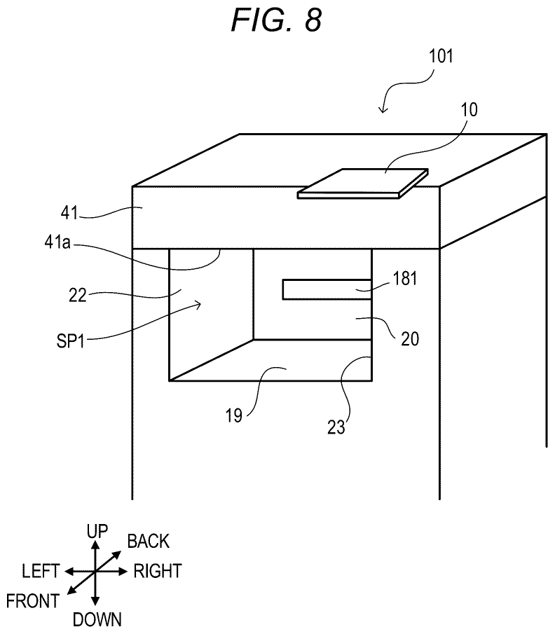

The in-body discharge space SP is not limited to that illustrated in FIG. 3 and FIG. 4. FIG. 8 is a perspective view for illustrating an in-body discharge space SP1 of an image forming apparatus 101 according to another embodiment. In the image forming apparatus 101, the in-body discharge space SP1 is formed so that the user standing in front toward the operation portion 10 and the discharge port 181 face each other. The in-body discharge space SP1 of the image forming apparatus 101 can be defined by five surfaces including the discharge tray 19 serving as a bottom surface, the discharge port surface 20, the lower surface 41a of the original reading portion 41 serving as an upper surface provided so as to be opposed to the discharge tray, a left side surface 22, and a right side surface 23. In this case, the sound absorbing device 13 formed of the in-body discharge cover 11 and the sound absorbing sheet 12 may be provided only on the left side surface (side surface) 22, may be provided only on the right side surface (another side surface) 23, or may be provided on both of the left side surface 22 and the right side surface 23.

### (In-Body Discharge Cover)

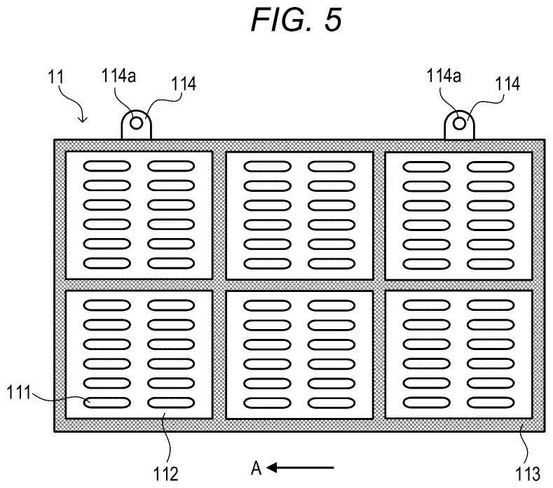

Next, the in-body discharge cover 11 in the first embodiment is described with reference to FIG. 5. FIG. 5 is a schematic view for illustrating the back side of the in-body discharge cover 11 in the first embodiment. The in-body discharge cover 11 in the first embodiment includes a perforated surface (perforated wall surface portion) 112, a sound absorbing sheet adhesive surface 113, and main body mounting portions 114. The perforated surface 112 has one or two or more sound absorbing holes 111 formed therein. A hole 114a for allowing a screw to pass therethrough is formed in each of the main body mounting portions 114. The screw is caused to pass through the hole 114a so as to be screwed into a screw hole formed in the main body of the image forming apparatus 1. Thus, the in-body discharge cover 11 is fixed to the main body of the image forming apparatus 1. At this time, in order to prevent the sound absorbing sheet 12 from being compressed, a gap in which the sound absorbing sheet 12 is arranged is formed between the in-body discharge cover 11 and the main body of the image forming apparatus 1.

An adhesive member, such as an adhesive, glue, or double-sided adhesive tape, for mounting the sound absorbing sheet 12 to the in-body discharge cover 11 is applied to the sound absorbing sheet adhesive surface 113. The sound absorbing sheet adhesive surface 113 may have a fastening member, such as a screw or a bolt, mounted thereto for mounting the sound absorbing sheet 12 to the in-body discharge cover 11. In the first embodiment, the sound absorbing sheet 12 is bonded to the in-body discharge cover 11 with double-sided adhesive tape having a pressure-sensitive adhesive property. However, when the double-sided adhesive tape closes even a part of the sound absorbing holes 111, the sound reduction effect obtained by the sound absorbing holes 111 is reduced as compared to a case in which the sound absorbing holes 111 are not closed. In view of the above, the double-sided adhesive tape bonds the sound absorbing sheet 12 to the sound absorbing sheet adhesive surface 113 (region indicated by hatching) in which no sound absorbing hole 111 is formed, in other words, a region other than regions in which the sound absorbing holes 111 are formed.

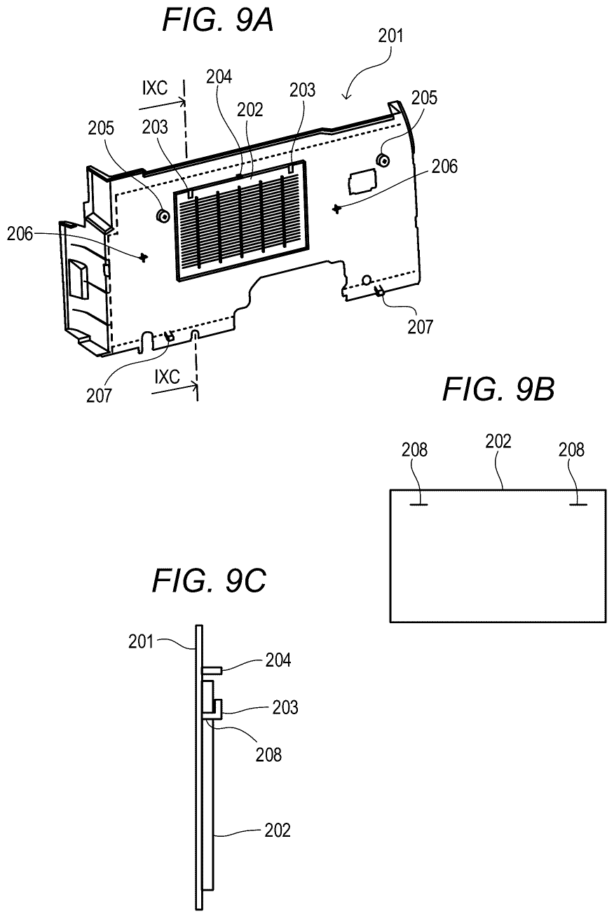

The in-body discharge cover 11 is not limited to the structure illustrated in FIG. 5. For example, the in-body discharge cover 11 may be configured to hold the sound absorbing sheet 12 without using the adhesive member. FIG. 9A, FIG. 9B, and FIG. 9C are views for illustrating an in-body discharge cover 201 and a sound absorbing sheet 202 in another embodiment. FIG. 9A is a perspective view of the in-body discharge cover 201 having the sound absorbing sheet 202 mounted thereon. In the in-body discharge cover 201, hook-shaped portions (engaging portions) 203, a retaining portion 204, bosses 205, center protrusion portions 206, and lower protrusion portions 207 are provided. FIG. 9B is a front view of the sound absorbing sheet 202. Slit portions (engaged portions) 208 passing through the sound absorbing sheet 202 are formed at an upper left portion and an upper right portion of the sound absorbing sheet 202. FIG. 9C is a sectional view taken along the line IXC-IXC of FIG. 9A. As illustrated in FIG. 9C, the hook-shaped portions 203 of the in-body discharge cover 201 are inserted into the slit portions 208 of the sound absorbing sheet 202 so that the sound absorbing sheet 202 is hung on the hook-shaped portions 203. In this manner, the sound absorbing sheet 202 is supported by the in-body discharge cover 201 in a form of being suspended by the hook-shaped portions 203. When the in-body discharge cover 201 is mounted to the main body of the image forming apparatus 1, at least one of the hook-shaped portions 203, the retaining portion 204, the bosses 205, the center protrusion portions 206, or the lower protrusion portions 207 of the in-body discharge cover 201 is brought into abutment against the main body of the image forming apparatus 1. In this manner, a gap in which the sound absorbing sheet 202 is arranged is formed between the in-body discharge cover 201 and the main body of the image forming apparatus 1 so that the sound absorbing sheet 202 is prevented from being compressed.

The hook-shaped portion 203 provided in the in-body discharge cover 201 is not limited to the shape illustrated in FIG. 9C, and is only required to be an engaging portion such as a protrusion. The slit portion 208 provided in the sound absorbing sheet 202 is not limited to the shape illustrated in FIG. 9B, and is only required to be an engaged portion, such as a hole, a recessed portion, or a through-hole, to be engaged with the engaging portion provided in the in-body discharge cover 201.

As described above, in order to reduce the sound output to the outside of the image forming apparatus 1 from the in-body discharge space SP, hitherto, there has been considered providing a muffling mechanism in the in-body discharge space SP. For example, a Helmholtz resonator serving as the muffling mechanism is included in the in-body discharge space SP so that the sound output to the outside of the image forming apparatus 1 from the in-body discharge space SP is reduced. However, the image forming apparatus 1 is recently desired to be further downsized, and the space in which the Helmholtz resonator can be installed in the in-body discharge space SP is limited. Specifically, if the frequency of the in-apparatus operating sound is “500 Hz,” because the speed of sound in air is “about 331,000 mm/s,” a Helmholtz resonator having a depth of about “50 mm” is required to be installed. However, the recent image forming apparatus 1 does not have such a large space that allows the Helmholtz resonator having such a size to be installed.

In view of the above, in the first embodiment, there is proposed a configuration of reducing the sound by holding the sound absorbing sheet 12 formed into a thickness of “5 mm” by the in-body discharge cover 11 having a thickness of about “3 mm.” In this manner, the sound output to the outside of the image forming apparatus 1 from the in-body discharge space SP can be reduced while the increase in size of the main body is suppressed. As illustrated in FIG. 4, in the first embodiment, a depth (distance) L of the gap in which the sound absorbing sheet 12 is arranged between the in-body discharge cover 11 and the main body of the image forming apparatus 1 is set to be about 6 mm in consideration of the thickness of the double-sided adhesive tape. Thus, according to the first embodiment, as compared to the case in which the Helmholtz resonator is installed, the space for arranging the sound absorbing device 13 may be greatly reduced.

### (Perforated Wall Surface Portion)

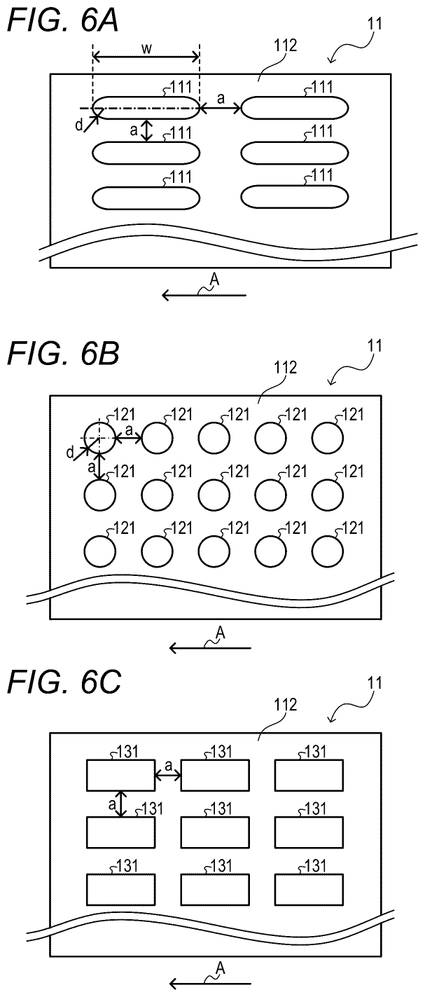

Next, with reference to FIG. 6A, FIG. 6B, and FIG. 6C, the configuration in the perforated surface 112 of the in-body discharge cover 11 is described. FIG. 6A, FIG. 6B, and FIG. 6C are schematic views of the perforated surface 112 of the in-body discharge cover 11 in the first embodiment. In the first embodiment, each of the sound absorbing holes 111 formed in the perforated surface 112 is, as illustrated in FIG. 6A, an elongated circular hole having a radius “d” of “1.5 mm or more and 6 mm or less” and a width “w” of “3 mm or more and 30 mm or less.” All of the sound absorbing holes 111 are not required to have the same hole diameter. When the radius “d” of the sound absorbing hole 111 is smaller than 1.5 mm, the strength of a mold for molding the in-body discharge cover 11 with resin may become weak. Thus, the radius “d” is set to be 1.5 mm or more. Meanwhile, when the radius “d” is larger than 6 mm, that is, the diameter is larger than 12 mm, because the width of an adult finger is larger than 12 mm in general, the finger of the user taking out the sheet S stacked in the in-body discharge space SP may erroneously enter the sound absorbing hole 111. Thus, the radius “d” is set to be 6 mm or less. In the first embodiment, all of the sound absorbing holes 111 are set to have the radius “d” of “3 mm” and the width “w” of “20 mm.”

The shape of the sound absorbing hole 111 is not limited to an elongated circular hole, and may be, as illustrated in FIG. 6B, a circular hole 121 having a radius “d” of 1.5 mm or more and 6 mm or less. Further, as illustrated in FIG. 6C, the sound absorbing hole 111 may be a quadrilateral hole 131 having one side of 1.5 mm or more and 30 mm or less. When the one side is larger than 30 mm, the strength and the rigidity of the in-body discharge cover 11 may not be kept. However, as long as the strength and the rigidity can be kept to the extent that the in-body discharge cover 11 does not bend even when being pressed from the outside, the one side may be larger than 30 mm. Further, it is preferred that the sound absorbing holes 111 being elongated circular holes, the circular holes 121, or the quadrilateral holes 131 be uniformly dispersed and arranged. In the first embodiment, the sound absorbing holes 111 being elongated circular holes, the circular holes 121, or the quadrilateral holes 131 are arranged at intervals “a” of 8 mm. In a portion of the in-body discharge cover 11 that may come into contact with the sheet S discharged from the discharge port 181, there is a possibility that the sheet S is caught by the quadrilateral hole 131, and hence the shape of the sound absorbing hole 111 being an elongated circular hole or the circular hole 121 is preferred.

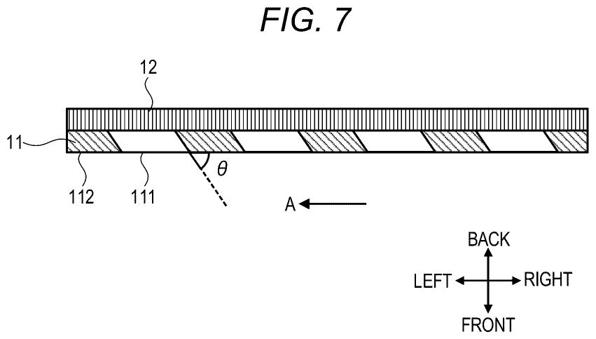

FIG. 7 is a sectional view of the perforated surface 112 of the in-body discharge cover 11 and the sound absorbing sheet 12 in the first embodiment. As illustrated in FIG. 7, the sound absorbing holes 111 are inclined at an inclination angle θ toward the discharge port 181 with respect to the surface of the in-body discharge cover 11. In the first embodiment, the sound absorbing holes 111 are inclined by 30 degrees (θ=30 degrees) in the direction of the discharge port 181 with respect to the surface of the in-body discharge cover 11. However, the inclination angle θ of the sound absorbing holes 111 with respect to the surface of the in-body discharge cover 11 is not limited to 30 degrees. The inclination angle θ may be any angle, but it is preferred that the inclination angle θ be set within a range of 45 degrees or less because the discharge port 181 and the in-body discharge cover 11 are arranged at a substantially right angle when the main body of the image forming apparatus 1 is viewed from the upper side. In this case, the main body operating sound output from the discharge port 181 is likely to enter the sound absorbing holes 111, and hence the sound reduction effect can be more enhanced.

A percentage of an area occupied by the plurality of sound absorbing holes 111 with respect to a surface area of a portion (main body portion) of the main body corresponding to the perforated surface 112 and the plurality of sound absorbing holes 111 (total area of the back of the in-body discharge space SP) is desired to be “35% or more.” The reason therefor is because, when the percentage of the area occupied by the plurality of sound absorbing holes 111 is smaller than 35%, an effective sound absorbing effect cannot be obtained. When the percentage of the area occupied by the plurality of sound absorbing holes 111 is larger than 50%, in general, the rigidity of the resin-made in-body discharge cover 11 is significantly reduced, and thus an effective rigidity of the in-body discharge cover 11 cannot be obtained. Accordingly, the percentage of the area of the plurality of sound absorbing holes 111 with respect to the area of the perforated surface 112 and the plurality of sound absorbing holes 111 (total area of the back of the in-body discharge space SP) is preferred to be “35% or more and 50% or less.” In the first embodiment, in consideration of the processability of the sound absorbing holes 111 with respect to the in-body discharge cover 11 and the rigidity of the in-body discharge cover 11, the percentage of the area occupied by the plurality of sound absorbing holes 111 with respect to the area of the perforated surface 112 and the plurality of sound absorbing holes 111 is 35% or more and 50% or less per unit area.

As described above, according to the first embodiment, the in-body discharge cover 11 in which the plurality of sound absorbing holes 111 are formed and those plurality of sound absorbing holes 111 are covered with the sound absorbing sheet 12 is used. Thus, the main body operating sound output from the discharge port 181 can be reduced with a small space. That is, when a part of the main body operating sound output from the discharge port 181 passes through the sound absorbing holes 111 to be diffused in the sound absorbing sheet 12, part of sound energy is converted into thermal energy so that the main body operating sound is reduced. In this manner, according to the first embodiment, a large sound reduction effect can be obtained with a small space without using a Helmholtz resonator as in the related art, and hence the increase in size of the main body of the image forming apparatus 1 can be suppressed. According to the first embodiment, the image forming apparatus 1 can be prevented from being increased in size, and transmission of the sound that is generated in the apparatus and output from the discharge port to the outside of the apparatus can be reduced. In the first embodiment, the sound absorbing configuration formed of the sound absorbing sheet 12 and the in-body discharge cover 11 including the plurality of sound absorbing holes 111 is arranged on the back of the in-body discharge space SP. Thus, the sound reflected on the back toward the front side of the image forming apparatus 1 (side on which the user operating the operation portion 10 stands) can be reduced, and hence this configuration is suitable for the user.

### Second Embodiment

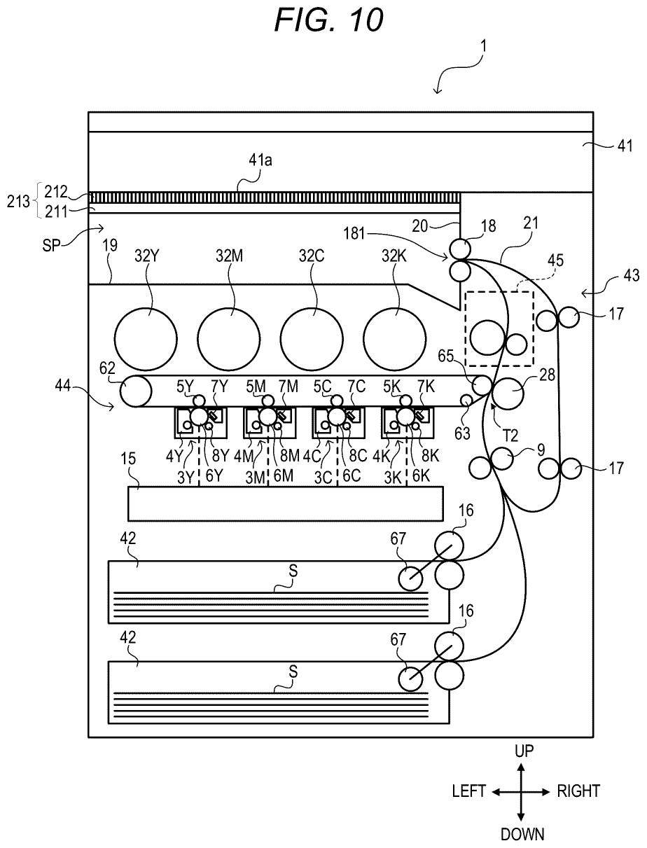

Next, with reference to FIG. 10, a second embodiment is described. The configuration of the second embodiment is different from the configuration of the first embodiment in that an in-body discharge cover 211 is provided in the upper portion of the in-body discharge space SP. However, other configurations are similar to those of the first embodiment, and hence the similar configurations are denoted by similar reference symbols to omit the detailed description thereof.

FIG. 10 is a sectional view of the image forming apparatus 1 according to the second embodiment. In the second embodiment, as illustrated in FIG. 10, the image forming apparatus 1 has a configuration in which the in-body discharge cover 211 having the plurality of sound absorbing holes 111 is provided on the upper side of the in-body discharge space SP. The in-body discharge cover 211 in the second embodiment defines the upper surface of the in-body discharge space SP. A sound absorbing device 213 formed of the in-body discharge cover 211 and a sound absorbing sheet 212 is mounted to an outer surface (lower surface) of a bottom plate (lower portion) of the original reading portion 41. In the second embodiment, the sound absorbing sheet (sound absorbing material) 212 is provided in abutment against the in-body discharge cover 211, but the sound absorbing sheet 212 may be arranged so as to be separated apart from the in-body discharge cover 211.

With the sound absorbing holes 111 being covered with the sound absorbing sheet 212, a part of the main body operating sound output from the discharge port 181 enters the sound absorbing sheet 212 through the sound absorbing holes 111. When the sound is greatly diffused in the sound absorbing sheet 212, part of sound energy is converted into thermal energy so that the sound is reduced. A percentage of an area occupied by the plurality of sound absorbing holes 111 with respect to a total area of the bottom plate (lower surface) of the original reading portion 41 is desired to be “35% or more and 50% or less.”

The plurality of sound absorbing holes 111 and the sound absorbing sheet 212 may be provided in the entire region of the in-body discharge cover 211, or may be provided in a part of the in-body discharge cover 211. The plurality of sound absorbing holes 111 and the sound absorbing sheet 212 may be provided in a plurality of parts of the in-body discharge cover 211. Further, the plurality of sound absorbing holes 111 and the sound absorbing sheet 212 may be provided in a part of the in-body discharge cover 211 on a side on which the operation portion 10 is provided with respect to a center position in a direction orthogonal to the discharge direction A of the recording medium. According to the second embodiment, the image forming apparatus 1 can be prevented from being increased in size, and transmission of the sound that is generated in the apparatus and output from the discharge port to the outside of the apparatus can be reduced.

### Third Embodiment

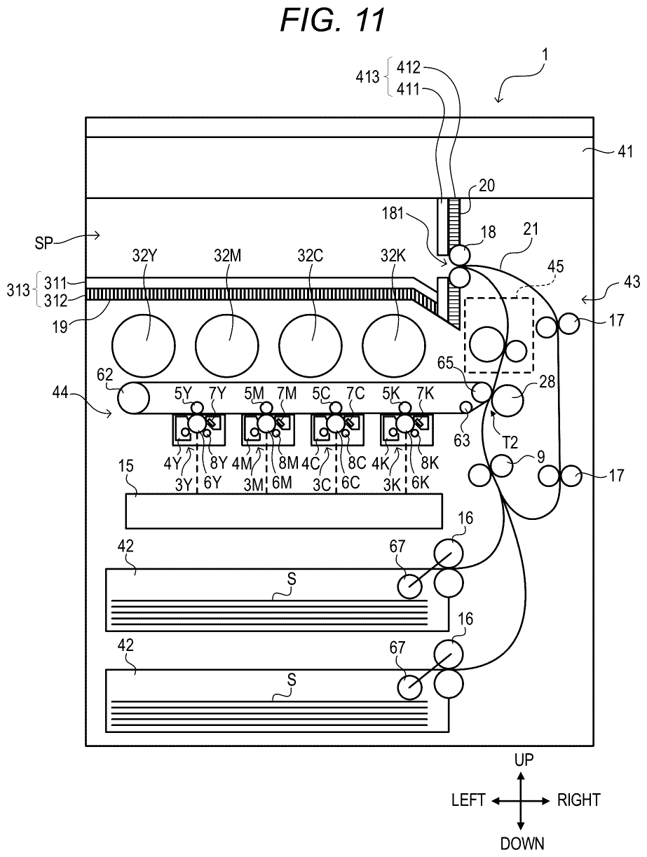

Next, with reference to FIG. 11, a third embodiment is described. The configuration of the third embodiment is different from the configuration of the first embodiment in that an in-body discharge cover 311 is provided in the discharge tray 19 serving as the bottom surface (bottom portion) of the in-body discharge space SP and in that an in-body discharge cover 411 is provided in the discharge port surface 20 serving as the wall portion. However, other configurations are similar to those of the first embodiment, and hence the similar configurations are denoted by similar reference symbols to omit the detailed description thereof.

FIG. 11 is a sectional view of the image forming apparatus 1 according to the third embodiment. In the third embodiment, as illustrated in FIG. 11, the image forming apparatus 1 has a configuration in which the in-body discharge cover 311 including the plurality of sound absorbing holes 111 is provided on the lower side of the in-body discharge space SP, and the in-body discharge cover 411 including the plurality of sound absorbing holes 111 is provided in the wall portion in which the discharge port 181 is provided. The in-body discharge cover 311 in the third embodiment defines the lower surface of the in-body discharge space SP. A sound absorbing device 313 formed of the in-body discharge cover 311 and a sound absorbing sheet 312 is mounted to the discharge tray 19 serving as a sheet stacking surface. In the third embodiment, the sound absorbing sheet (sound absorbing material) 312 is provided in abutment against the in-body discharge cover 311, but the sound absorbing sheet 312 may be arranged so as to be separated apart from the in-body discharge cover 311. With the sound absorbing holes 111 of the in-body discharge cover 311 being covered with the sound absorbing sheet 312, a part of the main body operating sound output from the discharge port 181 enters the sound absorbing sheet 312 through the sound absorbing holes 111. When the sound is greatly diffused in the sound absorbing sheet 312, part of sound energy is converted into thermal energy so that the sound is reduced. A percentage of an area occupied by the plurality of sound absorbing holes 111 with respect to a total area of the discharge tray 19 is desired to be “35% or more and 50% or less.”

The in-body discharge cover 411 in the third embodiment defines the wall portion of the in-body discharge space SP. A sound absorbing device 413 formed of the in-body discharge cover 411 and a sound absorbing sheet 412 is mounted to the discharge port surface 20 in which the discharge port 181 is formed. In the third embodiment, the sound absorbing sheet (sound absorbing material) 412 is provided in abutment against the in-body discharge cover 411, but the sound absorbing sheet 412 may be arranged so as to be separated apart from the in-body discharge cover 411. With the sound absorbing holes 111 of the in-body discharge cover 411 being covered with the sound absorbing sheet 412, a part of the main body operating sound output from the discharge port 181 enters the sound absorbing sheet 412 through the sound absorbing holes 111. When the sound is greatly diffused in the sound absorbing sheet 412, part of sound energy is converted into thermal energy so that the sound is reduced. A percentage of an area occupied by the plurality of sound absorbing holes 111 with respect to a total area of the discharge port surface 20 is desired to be “35% or more and 50% or less.” In the third embodiment, both of the in-body discharge covers 311 and 411 are provided in the in-body discharge space SP, but only one of the in-body discharge cover 311 or the in-body discharge cover 411 may be provided.

The sound absorbing configuration may be arranged in any member facing the in-body discharge space SP. For example, the sound absorbing configuration (sound absorbing device 313) may be arranged in the sheet stacking surface (discharge tray 19) (see FIG. 11). Further, the sound absorbing configuration (sound absorbing device 413) may be arranged in the discharge port surface 20 in which the discharge port 181 is formed (see FIG. 11). Further, the sound absorbing configuration (sound absorbing device 13) may be arranged in the side surface of the in-body discharge space SP (see FIG. 4). Further, the sound absorbing configuration (sound absorbing device 213) may be arranged in the upper surface of the in-body discharge space SP (see FIG. 10).

The sound absorbing configuration may be arranged in a plurality of surfaces facing the in-body discharge space SP. For example, the sound absorbing configuration may be arranged in both of the bottom plate of the original reading portion 41 and the back of the in-body discharge space SP. Further, the sound absorbing configuration may be arranged in the bottom plate of the original reading portion 41, the back of the in-body discharge space SP, and the sheet stacking surface (discharge tray 19). Moreover, the sound absorbing configuration may be arranged in the bottom plate of the original reading portion 41, the back of the in-body discharge space SP, the sheet stacking surface (discharge tray 19), and the discharge port surface 20 in which the discharge port 181 is formed.

The sound reduction can be achieved even when the sound absorbing configuration formed of the sound absorbing sheet 12 and the in-body discharge cover 11 including the plurality of sound absorbing holes 111 is mounted as a kit, that is, as an option unit, to a portion facing the discharge space of the image forming apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-109349, filed Jul. 3, 2023, and Japanese Patent Application No. 2024-078705, filed May 14, 2024, all of which are hereby incorporated by reference herein in their entirety.

What is claimed is:

1. An image forming apparatus comprising:
an image forming portion configured to form an image on a recording medium;
a discharge port configured to discharge the recording medium on which the image is formed by the image forming portion;
a wall portion in which the discharge port is provided;
a bottom portion on which the recording medium discharged from the discharge port is to be stacked;
an upper portion provided so as to be opposed to the bottom portion;
a side portion provided along a discharge direction of the recording medium discharged from the discharge port;
a discharge space defined by at least the wall portion, the bottom portion, the upper portion, and the side portion, wherein the discharge space accommodates the recording medium discharged from the discharge port;
a plurality of through-holes provided in any portion or portions of at least the wall portion, the bottom portion, the upper portion, and the side portion; and
a sound absorbing material provided so as to cover the plurality of through-holes on a side opposite to the discharge space with respect to the portion or portions of at least the wall portion, the bottom portion, the upper portion, and the side portion in which the plurality of through-holes are provided.

2. The image forming apparatus according to claim 1,
wherein the plurality of through-holes is provided in the side portion, and
wherein the sound absorbing material is provided on the side opposite to the discharge space with respect to the side portion.

3. The image forming apparatus according to claim 2, wherein the plurality of through-holes is provided in a part of the side portion.

4. The image forming apparatus according to claim 2, wherein a percentage of an area occupied by the plurality of through-holes with respect to an area of the side portion is 35% or more and 50% or less per unit area.

5. The image forming apparatus according to claim 1,
wherein the plurality of through-holes is provided in the upper portion, and
wherein the sound absorbing material is provided on the side opposite to the discharge space with respect to the upper portion.

6. The image forming apparatus according to claim 5, further comprising an operation portion to be operated by a user,
wherein the plurality of through-holes is provided in a part of the upper portion on a side on which the operation portion is provided.

7. The image forming apparatus according to claim 1, further comprising another side portion provided so as to be opposed to the side portion,
wherein the plurality of through-holes is provided in the another side portion or in both of the side portion and the another side portion,
wherein the sound absorbing material is provided on the side opposite to the discharge space with respect to the another side portion, and
wherein the sound absorbing material is provided on the side opposite to the discharge space with respect to the side portion in a case in which the plurality of through-holes is provided in the side portion.

8. The image forming apparatus according to claim 1, wherein the sound absorbing material has a sheet shape.

9. The image forming apparatus according to claim 1,
wherein the sound absorbing material is formed into a sheet shape with any one of an ethylene propylene diene rubber-based or urethane-based foam, glass wool, or rockwool, and
wherein the sound absorbing material is in abutment against the portion or portions of at least the wall portion, the bottom portion, the upper portion, and the side portion in which the plurality of through-holes is provided.

10. The image forming apparatus according to claim 1, wherein the plurality of through-holes has a circular hole having a radius of 1.5 mm or more and 6 mm or less or an elongated circular hole having a radius of 1.5 mm or more and 6 mm or less and a width of 3 mm or more and 30 mm or less.

11. The image forming apparatus according to claim 1, wherein the plurality of through-holes has a quadrilateral hole having one side of 1.5 mm or more and 30 mm or less.

12. The image forming apparatus according to claim 1, wherein the plurality of through-holes is inclined toward the wall portion.

13. The image forming apparatus according to claim 1, wherein the sound absorbing material is bonded to the portion or portions of the wall portion, the bottom portion, the upper portion, and the side portion by an adhesive member.

14. The image forming apparatus according to claim 1,
wherein the portion or portions of the wall portion, the bottom portion, the upper portion, and the side portion is provided with an engaging portion,
wherein the sound absorbing material is provided with an engaged portion, and
wherein the engaged portion of the sound absorbing material is engaged with the engaging portion of the portion or portions of the wall portion, the bottom portion, the upper portion, and the side portion in which the plurality of through-holes is provided.

15. The image forming apparatus according to claim 1, further comprising a reader provided above the discharge space and configured to read an image of an original,
wherein the reader includes the upper portion.

16. An image forming apparatus comprising:
an image forming portion configured to form an image on a recording medium;
a discharge port configured to discharge the recording medium on which the image is formed by the image forming portion;
a discharge space in which the recording medium discharged from the discharge port is to be accommodated in a stacked state;
a member facing the discharge space and defining the discharge space;
a plurality of through-holes provided in the member; and
a sound absorbing material provided so as to cover the plurality of through-holes on a side opposite to the discharge space with respect to the member.

17. The image forming apparatus according to claim 16, wherein the member, in which the plurality of through-holes is provided, is a side portion provided along a discharge direction of the recording medium discharged from the discharge port.

18. The image forming apparatus according to claim 16, further comprising a bottom portion on which the recording medium discharged from the discharge port is to be stacked,
wherein the member, in which the plurality of through-holes is provided, is provided so as to be opposed to the bottom portion.

19. The image forming apparatus according to claim 16, wherein the member, in which the plurality of through-holes is provided, is a bottom portion on which the recording medium discharged from the discharge port is to be stacked.

20. The image forming apparatus according to claim 16, wherein the member, in which the plurality of through-holes is provided, is a wall portion in which the discharge port is provided.

21. The image forming apparatus according to claim 16, wherein the sound absorbing material has a sheet shape.
